(19) United States
(12) Patent Application Publication
(10) Pub. No.: US 2016/0092571 A1
(43) Pub. Date: Mar. 31, 2016

(54) SEARCH RELEVANCE

(71) Applicants: Kumaresh Pattabiraman, Sunnyvale, CA (US); Sachit Kamat, San Carlos, CA (US); Eduardo Vivas, Miami, FL (US)

(72) Inventors: Kumaresh Pattabiraman, Sunnyvale, CA (US); Sachit Kamat, San Carlos, CA (US); Eduardo Vivas, Miami, FL (US)

(21) Appl. No.: 14/581,849

(22) Filed: Dec. 23, 2014

Related U.S. Application Data
(60) Provisional application No. 62/057,877, filed on Sep. 30, 2014.

(51) Int. Cl. G06F 17/30

(52) U.S. Cl. CPC G06F 17/30864; G06F 17/3053

(57) ABSTRACT

Systems, methods and a machine-readable media are described herein for a relevance booster module to calculate a relevance, with respect to at least one characteristic of a query, of each piece of content in a set of collected content and a set of premium content. The relevance booster module increases a calculated relevance of at least one piece of content in the set of premium content. The relevance booster module generates a list in which each piece of content in the set of collected content and the set of premium content is ranked according to a respective calculated relevance.

### CROSS-REFERENCE TO RELATED APPLICATIONS

This application claims priority to U.S. Provisional Application No. 62/057,877, filed Sep. 30, 2014, and entitled “SEARCH RELEVANCE BOOSTING FOR PREMIUM CONTENT”, which is incorporated by reference herein in its entirety.

### TECHNICAL FIELD

The present disclosure generally relates to data processing systems. More specifically, the present disclosure relates to methods, systems and computer program products for ranking content.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing the functional components of a social network service within a networked system, in accordance with an example embodiment;

FIG. 3 is a block diagram showing example components of a relevance booster module, according to some embodiments;

FIG. 4 is a block diagram showing an example ranked list, according to some embodiments;

FIG. 5 is a block diagram showing an example modified ranked list, according to some embodiments;

FIG. 6 is a flowchart illustrating a method of generating a list, in accordance with an example embodiment;

FIG. 7 is a block diagram of an example computer system on which methodologies described herein may be executed, in accordance with an example embodiment.

### DETAILED DESCRIPTION

The present disclosure describes methods and systems for generating a ranked list in a professional social networking service. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Consistent with embodiments of the invention, and as described in detail herein, a professional social networking service (hereinafter “social network” or “social network service”) includes the necessary logic for a relevance booster module to calculate a relevance, with respect to at least one characteristic of a query, of each piece of content in a set of collected content and a set of premium content. The relevance booster module increases a calculated relevance of at least one piece of content in the set of premium content. The relevance booster module generates a list in which each piece of content in the set of collected content and the set of premium content is ranked according to a respective calculated relevance.

In one embodiment, a professional social networking service stores a set of free job posting (“free set”) and a set of premium job postings (“premium set”). The set of free job postings comprises content created external to the professional social networking service. The set of premium job postings comprises content created within the professional social networking service. The relevance booster module calculates a relevance score for each respective job posting in both the free and premium sets with respect the job posting's relevance to at least one of a search query keyword, professional social network member profile data, professional social network member behaviour data and any other kind of data in the professional social networking service.

The relevance booster module generates a list that ranks the calculated relevance scores of the job postings. In some embodiments, the relevance booster module increases a relevance score to one or more job postings from the premium set according to one or more tunable weights.

In other embodiments, the relevance booster module divides the list into a plurality of segments, where each segment reserved a pre-defined number of top ranked positions for premium job postings. For example, a first segment has the first ten ranked positions (1-10), with ranked positions 1-3 reserved for premium job postings. The second segment has the second ten ranked positions (11-20), with ranked positions 11-13 reserved for premium job postings.

The relevance booster module identifies the three premium job postings that have the highest relevance score among all the premium job postings present in the top ten ranked positions (1-10) of the first segment. The relevance booster module places the three identified premium job postings at positions 1-3 of the first segment. For positions 4-10 in the first segment, the relevance booster module ranks the remaining premium job postings and free job postings present in the first segment according to their respect relevance score.

The relevance booster module identifies the three premium job postings that have the highest relevance score among all the premium job postings present in the top ten ranked positions (11-20) of the second segment. The relevance booster module places the three identified premium job postings at positions 11-13 of the second segment. For positions 14-20 in the second segment, the relevance booster module ranks the remaining premium job postings and free job postings present in the second segment according to their respect relevance score.

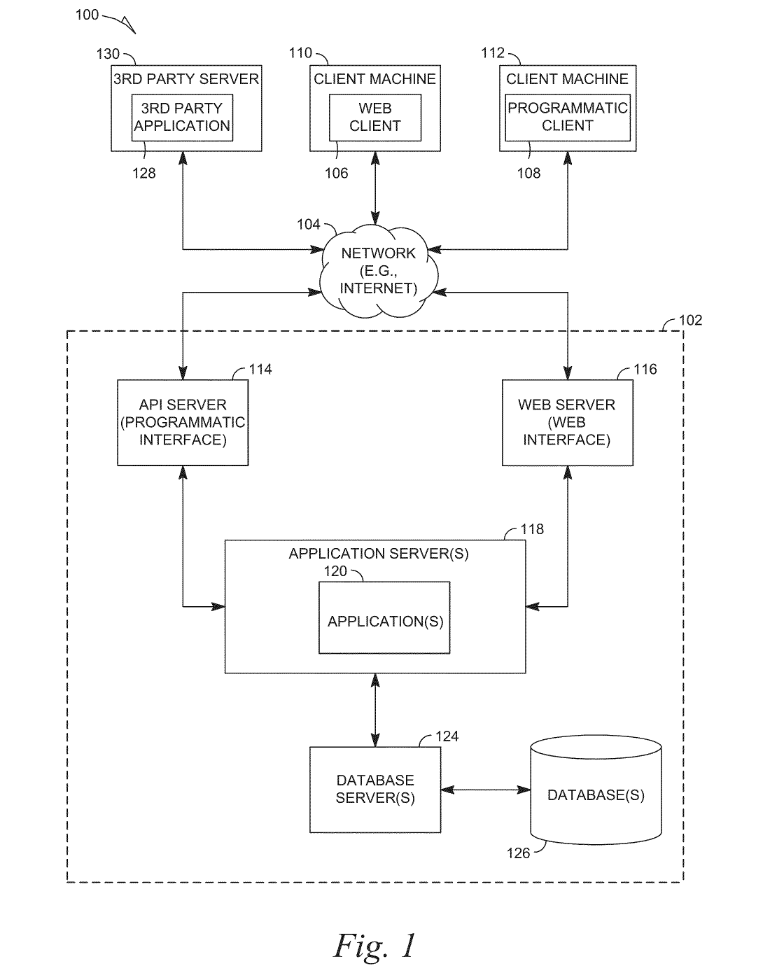

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a social network service.

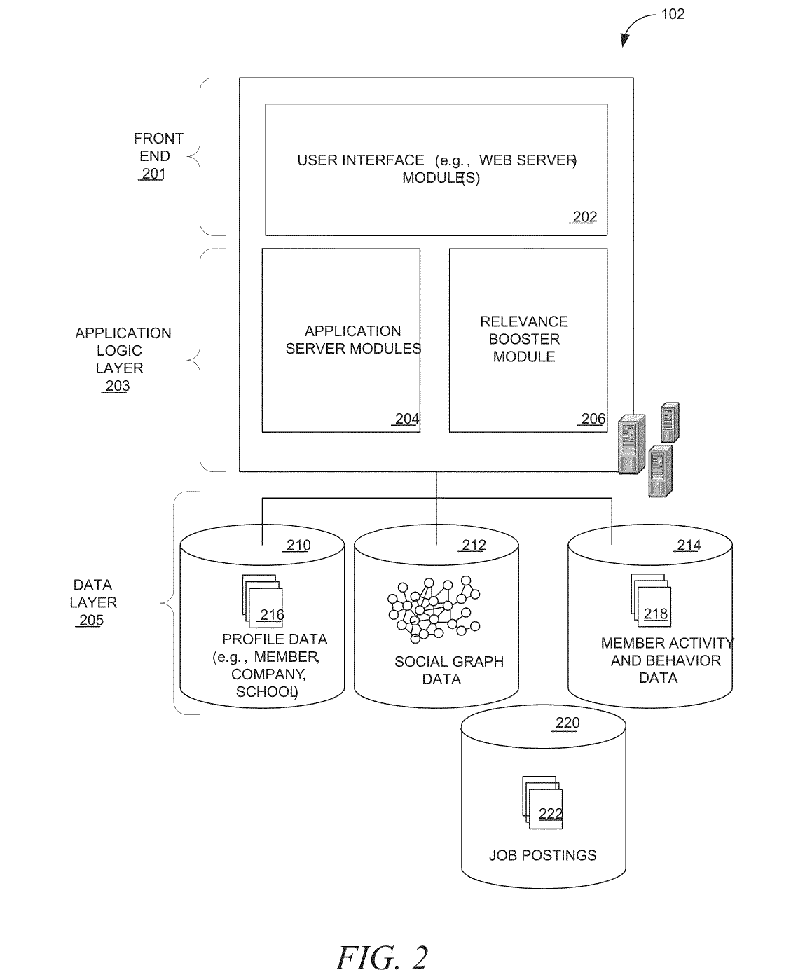

FIG. 2 is a block diagram showing functional components of a social network service within the networked system 102, in accordance with an example embodiment. As shown in FIG. 2, the social network service may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a social network system, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a social network service is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the social network service. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the social network service, the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the social network service. These settings may comprise various categories, including, but not limited to, privacy and communications. Each category may have its own set of settings that a member may control.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behaviour (e.g., content viewed, links or member-interest buttons selected, etc.) may be monitored and information 218 concerning the member's activities and behaviour may be stored, for example, as indicated in FIG. 2, by the database 214. This information 218 may be used to classify the member as being in various categories. For example, if the member performs frequent searches of job listings, thereby exhibiting behaviour indicating that the member is a likely job seeker, this information 218 can be used to classify the member as a job seeker. This classification can then be used as a member profile attribute for purposes of enabling others to target the member for receiving messages, status updates and/or a list of ranked premium and free job postings.

The data layer 205 further includes a jobs repository 220 which includes content comprising various types of job postings. The jobs repository includes job postings created at and collected from multiple sources outside of the professional social networking service, such as descriptions of jobs submitted to various job posting websites from various users free of charge. The jobs repository also includes premium job postings created by members of the professional social networking service. In some embodiments, various members create and customize respective job postings to be displayed within the professional social networking service for a fee.

In some embodiments, the professional social networking service provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., a smartphone, or tablet computing devices) having a mobile operating system.

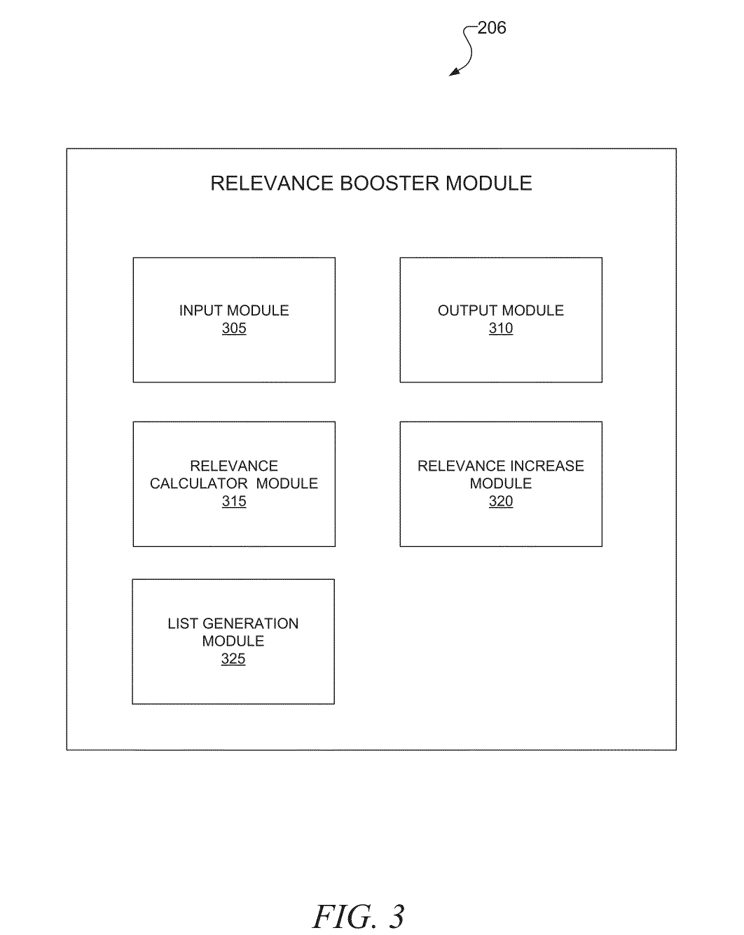

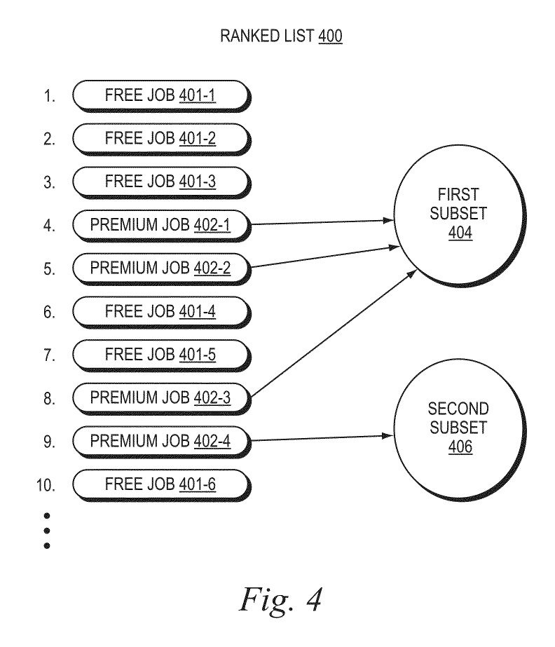

The data and information (e.g., profile data 216, member activity and behaviour data 218, trained salary data 222) in the data layer 205 may be accessed, used, and adjusted by the relevance booster module 206 as will be described in more detail below in conjunction with FIGS. 3-4. Although the relevance booster module 206 is referred to herein as being used in the context of a social network service, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

FIG. 3 is a block diagram showing example components of a relevance booster module, according to some embodiments. The input module 305 is a hardware-implemented module which receives and processes any inputs from one or more components of system 102 as illustrated in FIG. 1 and FIG. 2. In various embodiments, the inputs include one or more portions of content collected from a source outside of the professional social network service, one or more portions of premium content sourced from within the professional social network service and a query based one or more attributes of one or more members of the professional social network service.

The output module 310 is a hardware-implemented module which sends any outputs to one or more components of system 100 of FIG. 1 (e.g., one or more client devices 110, 112, third party server 130, etc.). In some embodiments, the outputs are data representative of a ranked list as described herein. In some embodiment, the data representative of the ranked list may be sent to one or more client devices 110, 112 for display at the client devices 110, 112.

The relevance calculator module 315 is a hardware implemented module which manages, controls, stores, and accesses information associated with calculating a relevancy score for one or more portions of collected content and/or one or more portions of premium content with respect to the query.

The relevance increase module 320 is a hardware-implemented module which manages, controls, stores, and accesses information associated with increasing a calculated relevancy score of at least one portion of premium content.

The list generation module 325 is a hardware-implemented module which manages, controls, stores, and accesses information associated with generated a ranked list in which each piece of collected content and premium content is ranked according to a respective calculated relevance score.

FIG. 4 is a block diagram showing an example ranked list 400, according to some embodiments. The relevance booster module 206 accesses, in the jobs repository 220, a set of free job postings collected from various sources external to the professional social networking service. The relevance booster module 206 also accesses, in the job repository 220, a set of premium jobs customized by and received from various members of the professional social networking service to be displayed within the professional social networking service for a fee.

The relevance booster module 206 identifies a particular member of the professional social networking service to whom various job postings will be shown. The relevance booster module 206 identifies data about the particular member, such as profile data, data about the member's browsing behaviours, and data related to the member's connections with other member's, etc. Based on such identified data about the member, the relevance booster module 206 determines which job postings in both the set of free job postings and the set of premium job postings are relevant to the particular member. The relevance booster module 206 calculates a relevance score for each free job posting 401-1, 401-2, 401-3, 401-4, 401-5, 401-6 and each premium job posting 402-1, 402-2, 402-3, 402-4.

The relevance booster module 206 increases the calculated relevance score for each premium job posting 402-1, 402-2, 402-3, 402-4. For example, the relevance booster module 206 can apply one or more weights (or tunable weights) to each premium job posting 402-1, 402-2, 402-3, 402-4 that increases each premium job posting's calculated relevance score. The relevance booster module 206 generates a ranked list 400 based on ranking the calculated relevance scores for each free job posting and for each premium job posting.

As shown in FIG. 4, the ten job postings with the highest ten relevance scores from the set of free job postings and the set of premium job postings are free job postings 401-1, 401-2, 401-3, 401-4, 401-5, 401-6 and premium job postings 402-1, 402-2, 402-3, 402-4.

The relevance booster module 206 identifies one or more segments in the ranked list 400. For example, as shown in FIG. 4, each segment includes ten positions in the ranked list 400. The relevance booster module 206 further defines the first three positions in each segment of the ranked list 400 as positions for premium job postings with the highest calculated relevance scores among all premium job postings present in the segment. The relevance booster module 206 identifies a first subset of premium content 404 as including the three highest relevant premium job postings 402-1, 402-2, 402-3 in the segment. The relevance booster module 206 identifies a second subset of premium content 406 that includes the remaining premium job postings 402-4 in the segment.

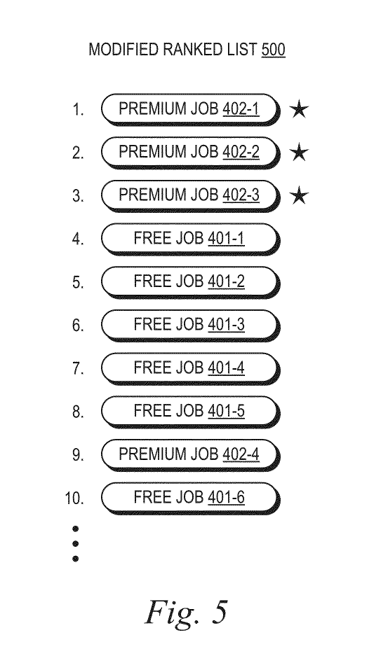

FIG. 5 is a block diagram showing an example modified ranked list 500, according to some embodiments. The relevance booster module 206 places the premium job postings 402-1, 402-2, 402-3 in the first three positions of the segment of the ranked list to create a modified ranked list 500. In the remaining positions (e.g. 4-10) of the segment of the modified ranked list 500, the relevance booster module 206 ranks free job postings 401-1, 401-2, 401-3, 401-4, 401-5, 401-6 and premium job 401-6 according to their respective calculated relevance score.

The relevance booster module 206 adds a graphical characteristic (such as, for example, a star graphic illustrated in FIG. 5) to each premium job posting 402-1, 402-2, 402-3 to visually distinguish the display of the premium job posting 402-1, 402-2, 402-3.

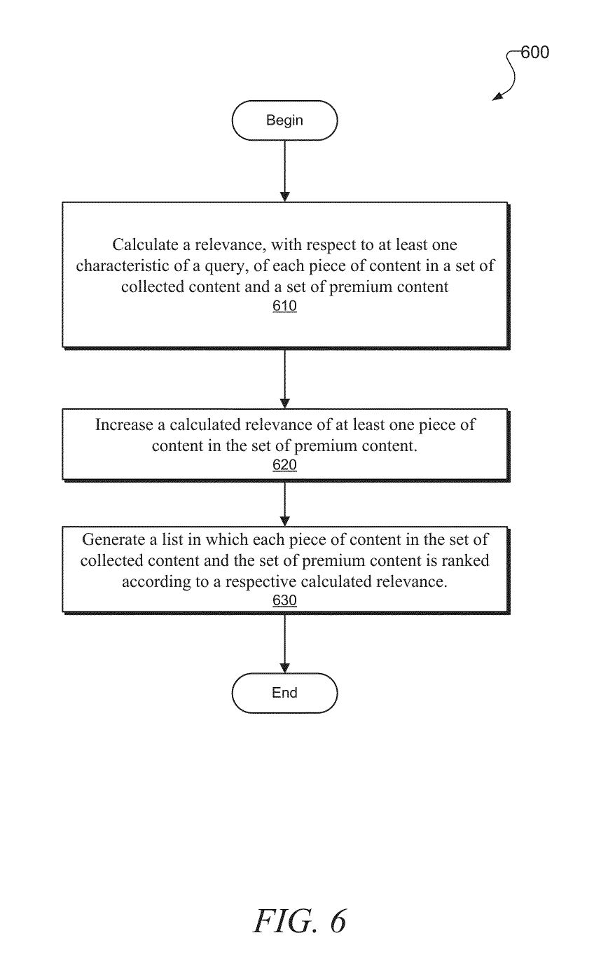

FIG. 6 is a flowchart illustrating a method 600 of generating a list, in accordance with an example embodiment;

At operation 610, the relevance booster module 206 calculates a relevance, with respect to at least one characteristic of a query, of each piece of content in a set of collected content and a set of premium content.

At operation 620, the relevance booster module 206 increases a calculated relevance of at least one piece of content in the set of premium content.

At operation 630, a relevance booster module 206 generates a list in which each piece of content in the set of collected content and the set of premium content is ranked according to a respective calculated relevance.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled.

A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

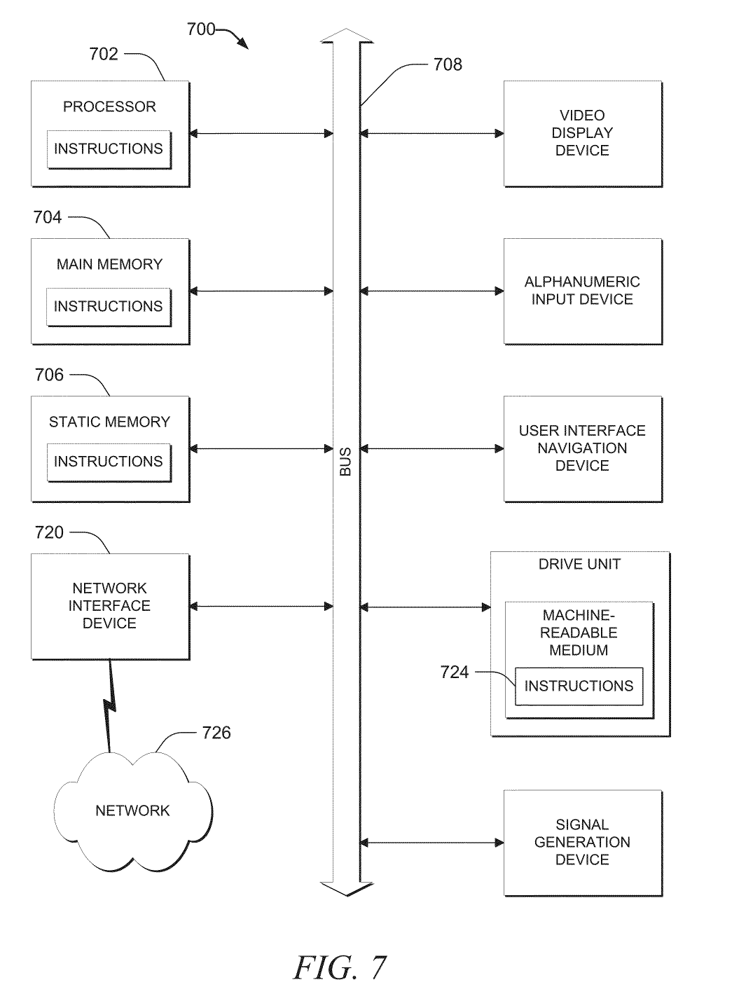

FIG. 7 is a block diagram of a machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 700 includes a processor 702 (e.g., a central processing unit (CPU), a graphics processing unit (GPU) or both), a main memory 704, and a static memory 706, which communicate with each other via a bus 708. Computer system 700 may further include a video display device 710 (e.g., a liquid crystal display (LCD) or a cathode ray tube (CRT)). Computer system 700 also includes an alphanumeric input device 712 (e.g., a keyboard), a user interface (UI) navigation device 714 (e.g., a mouse or touch sensitive display), a disk drive unit 716, a signal generation device 718 (e.g., a speaker) and a network interface device 720.

Disk drive unit 716 includes a machine-readable medium 722 on which is stored one or more sets of instructions and data structures (e.g., software) 724 embodying or utilized by any one or more of the methodologies or functions described herein. Instructions 724 may also reside, completely or at least partially, within main memory 704, within static memory 706, and/or within processor 702 during execution thereof by computer system 700, main memory 704 and processor 702 also constituting machine-readable media.

While machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 724 may further be transmitted or received over a communications network 726 using a transmission medium. Instructions 724 may be transmitted using network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method, comprising:
calculating a relevance, with respect to at least one characteristic of a query, of each piece of content in a set of collected content and a set of premium content;
increasing a calculated relevance of at least one piece of content in the set of premium content; and
generating a list in which each piece of content in the set of collected content and the set of premium content is ranked according to a respective calculated relevance.

2. The computer-implemented method as in claim 1, wherein calculating a relevance, with respect to at least one characteristic of a query, of each piece of content in a set of collected content and a set of premium content comprises:
creating the set of collected content based on content sourced from outside of a professional social network service; and
creating the set of premium content based on content sourced from within the professional social network service.

3. The computer-implemented method as in claim 2, further comprising:
wherein the content sourced from outside of the professional social network service comprises a first set of jobs postings;
wherein the content created sourced from within the professional social network service comprises a second set of jobs postings submitted by respective members of the professional social network service; and
wherein the at least one characteristic of the query comprises an attribute of a particular member of the professional social network service.

4. The computer-implemented method as in claim 1, wherein generating a list in which each piece of content in the set of collected content and the set of premium content is ranked according to a respective calculated relevance comprises:
identifying a first segment of the list and a second segment of the list;
identifying a first subset of premium content present in the first segment of the list;
identifying a second subset of premium content present in the first segment of the list, the first subset of premium content comprising content with a calculated relevance higher than content in the second subset of premium content;
identifying a first subset of collected content present in the first segment of the list; and
in the first segment of the list, positioning each piece of content from the first subset of premium content list before the second subset of premium content and before the first subset of collected content.

5. The computer-implemented method as in claim 4, further comprising:
identifying a third subset of premium content present in the second segment of the list;
identifying a fourth subset of premium content present in the second segment of the list, the third subset of premium content comprising content with a calculated relevance higher than content in the fourth subset of premium content;
identifying a second subset of collected content present in the second segment of the list; and
in the second segment of the list, positioning each piece of content from the third subset of premium content before the fourth subset of premium content and before the second subset of collected content.

6. The computer-implemented method as in claim 5, further comprising:
adding a graphical characteristic to the first subset of premium content to visually distinguish a display of the first subset of premium content from a display of the second subset of premium content and a display of the first subset of the collected content; and
adding the graphical characteristic to the third subset of premium content to visually distinguish a display of the third subset of premium content from a display of the fourth subset of premium content and a display of the second subset of the collected content.

7. The computer-implemented method as in claim 5, further comprising:
wherein the first subset of premium content comprises a pre-defined number of pieces of premium content;
wherein the third subset of premium content comprises the pre-defined number of pieces of premium content; and
wherein the first segment of the list and the second segment of the list each comprise a same pre-defined number of ranked positions for pieces of content.

8. A computer-readable medium storing executable instructions thereon, which, when executed by a processor, cause the processor to perform operations including:
calculating a relevance, with respect to at least one characteristic of a query, of each piece of content in a set of collected content and a set of premium content;
increasing a calculated relevance of at least one piece of content in the set of premium content; and
generating a list in which each piece of content in the set of collected content and the set of premium content is ranked according to a respective calculated relevance.

9. The computer-readable medium as in claim 8, wherein calculating a relevance, with respect to at least one characteristic of a query, of each piece of content in a set of collected content and a set of premium content comprises:
creating the set of collected content based on content sourced from outside of a professional social network service; and
creating the set of premium content based on content sourced from within the professional social network service.

10. The computer-readable medium as in claim 9, further comprising:
wherein the content sourced from outside of the professional social network service comprises a first set of jobs postings;
wherein the content created sourced from within the professional social network service comprises a second set of jobs postings submitted by respective members of the professional social network service; and
wherein the at least one characteristic of the query comprises an attribute of a particular member of the professional social network service.

11. The computer-readable medium as in claim 8, wherein generating a list in which each piece of content in the set of collected content and the set of premium content is ranked according to a respective calculated relevance comprises:
identifying a first segment of the list and a second segment of the list;
identifying a first subset of premium content present in the first segment of the list;
identifying a second subset of premium content present in the first segment of the list, the first subset of premium content comprising content with a calculated relevance higher than content in the second subset of premium content;
identifying a first subset of collected content present in the first segment of the list; and
in the first segment of the list, positioning each piece of content from the first subset of premium content list before the second subset of premium content and before the first subset of collected content.

12. The computer-readable medium as in claim 11, further comprising:
identifying a third subset of premium content present in the second segment of the list;
identifying a fourth subset of premium content present in the second segment of the list, the third subset of premium content comprising content with a calculated relevance higher than content in the fourth subset of premium content;
identifying a second subset of collected content present in the second segment of the list; and
in the second segment of the list, positioning each piece of content from the third subset of premium content before the fourth subset of premium content and before the second subset of collected content.

13. The computer-readable medium as in claim 12, further comprising:
adding a graphical characteristic to the first subset of premium content to visually distinguish a display of the first subset of premium content from a display of the second subset of premium content and a display of the first subset of the collected content; and
adding the graphical characteristic to the third subset of premium content to visually distinguish a display of the third subset of premium content from a display of the fourth subset of premium content and a display of the second subset of the collected content.

14. The computer-readable medium as in claim 12, further comprising:
wherein the first subset of premium content comprises a pre-defined number of pieces of premium content;
wherein the third subset of premium content comprises the pre-defined number of pieces of premium content; and
wherein the first segment of the list and the second segment of the list each comprise a same pre-defined number of ranked positions for pieces of content.

15. A computer system comprising:
a processor;
a memory device holding an instruction set executable on the processor to cause the computer system to perform operations comprising:
calculating a relevance, with respect to at least one characteristic of a query, of each piece of content in a set of collected content and a set of premium content;
increasing a calculated relevance of at least one piece of content in the set of premium content; and
generating a list in which each piece of content in the set of collected content and the set of premium content is ranked according to a respective calculated relevance.

16. The computer system as in claim 15, wherein calculating a relevance, with respect to at least one characteristic of a query, of each piece of content in a set of collected content and a set of premium content comprises:
creating the set of collected content based on content sourced from outside of a professional social network service; and
creating the set of premium content based on content sourced from within the professional social network service.

17. The computer system as in claim 16, further comprising:
wherein the content sourced from outside of the professional social network service comprises a first set of jobs postings;
wherein the content created sourced from within the professional social network service comprises a second set of jobs postings submitted by respective members of the professional social network service; and
wherein the at least one characteristic of the query comprises an attribute of a particular member of the professional social network service.

18. The computer system as in claim 15, wherein generating a list in which each piece of content in the set of collected content and the set of premium content is ranked according to a respective calculated relevance comprises:
identifying a first segment of the list and a second segment of the list;
identifying a first subset of premium content present in the first segment of the list;
identifying a second subset of premium content present in the first segment of the list, the first subset of premium content comprising content with a calculated relevance higher than content in the second subset of premium content;
identifying a first subset of collected content present in the first segment of the list; and
in the first segment of the list, positioning each piece of content from the first subset of premium content list before the second subset of premium content and before the first subset of collected content.

19. The computer system as in claim 18, further comprising:
identifying a third subset of premium content present in the second segment of the list;
identifying a fourth subset of premium content present in the second segment of the list, the third subset of premium content comprising content with a calculated relevance higher than content in the fourth subset of premium content;
identifying a second subset of collected content present in the second segment of the list; and
in the second segment of the list, positioning each piece of content from the third subset of premium content before the fourth subset of premium content and before the second subset of collected content.

20. The computer system as in claim 19, further comprising:
adding a graphical characteristic to the first subset of premium content to visually distinguish a display of the first subset of premium content from a display of the second subset of premium content and a display of the first subset of the collected content;
adding the graphical characteristic to the third subset of premium content to visually distinguish a display of the third subset of premium content from a display of the fourth subset of premium content and a display of the second subset of the collected content;
wherein the first subset of premium content comprises a pre-defined number of pieces of premium content;
wherein the third subset of premium content comprises the pre-defined number of pieces of premium content; and
wherein the first segment of the list and the second segment of the list each comprise a same pre-defined number of ranked positions for pieces of content.
